(19) United States
(12) Patent Application Publication
(10) Pub. No.: US 2026/0112747 A1
(43) Pub. Date: Apr. 23, 2026

(54) Secondary Battery and Method of Manufacturing Secondary Battery

(71) Applicant: SK On Co., Ltd., Seoul (KR)

(72) Inventors: Seung Ho KWAK, Daejeon (KR); Soo Min PARK, Daejeon (KR); Jae Yun PARK, Daejeon (KR); Joo Hyuk LEE, Daejeon (KR); Myeong Shin CHO, Daejeon (KR); Soo In PARK, Gyeonggi-do (KR)

(21) Appl. No.: 19/356,288

(22) Filed: Oct. 13, 2025

(30) Foreign Application Priority Data
Oct. 18, 2024 (KR) 10-2024-0142825

(51) Int. Cl. H01M 50/169; H01M 10/04; H01M 50/107; H01M 50/152; H01M 50/342; H01M 50/538; H01M 50/567

(52) U.S. Cl. CPC H01M 50/169; H01M 10/049; H01M 50/107; H01M 50/152; H01M 50/3425; H01M 50/538; H01M 50/567

(57) ABSTRACT

Provided are a secondary battery and a method of manufacturing the secondary battery. According to one aspect of the present disclosure, the secondary battery includes a can, an electrode assembly disposed inside the can, a rivet disposed on one surface of the can and electrically connected to a first electrode tab of the electrode assembly, and a cap plate disposed on a surface opposite to the one surface, fastened to the can to close an opening of the can, and electrically connected to a second electrode tab of the electrode assembly, wherein the cap plate includes a bonding region welded to the second electrode tab, the bonding region is provided with a metal layer on an inner surface facing the second electrode tab, and the metal layer is at least partially melted by welding heat applied to the bonding region and bonded to the second electrode tab.

### CROSS-REFERENCE TO RELATED APPLICATION

The present application claims priority to and the benefit of Korean Patent Application No. 10-2024-0142825, filed on Oct. 18, 2024 in the Korean Intellectual Property Office, the entire disclosure of which is incorporated herein by reference.

### BACKGROUND

### 1. Field of the Invention

Embodiments of the present disclosure relate to a secondary battery and a method of manufacturing the secondary battery.

### 2. Discussion of Related Art

A secondary battery is known as one type of energy storage means that can be charged and discharged through an electrochemical reaction. The secondary battery is widely used in various fields using electrical energy. For example, the secondary battery is widely used in the field of mobile devices such as mobile phones, laptops, and tablets, and broader use is being sought in the field of transportation means such as vehicles, aircraft, and ships. In addition, demand for secondary batteries is increasing in the field of energy storage systems (ESSs) for utilizing surplus power.

The secondary batteries may be classified into a pouch type, a prismatic type, a cylindrical type, a coin type, and the like depending on the packaging form. Demand for cylindrical secondary batteries has been rapidly increasing in recent years in the vehicle field due to their relatively low manufacturing costs. The cylindrical secondary battery may have a structure in which a jelly-roll type electrode assembly is accommodated in a can together with an electrolyte. The electrode assembly may have a structure in which a positive electrode and a negative electrode having a sheet form are disposed with a separator interposed therebetween and wound into a roll shape.

As the demand for secondary batteries increases in various fields, the industry is actively exploring ways to improve the manufacturing cost or convenience of secondary batteries. For example, cylindrical secondary batteries used in the vehicle field are gradually increasing in size, and ways to improve manufacturing cost or convenience are being explored in response. Furthermore, despite improvements in manufacturing cost or convenience, the quality or performance of secondary batteries needs to be appropriately maintained.

### SUMMARY OF THE INVENTION

Some embodiments of the present disclosure are directed to providing a secondary battery and a method of manufacturing the secondary battery.

Some embodiments of the present disclosure are also directed to providing a secondary battery and a method of manufacturing the secondary battery that can reduce manufacturing costs.

Some embodiments of the present disclosure are also directed to providing a secondary battery and a method of manufacturing the secondary battery that can reduce assembly defects.

At least some embodiments of the present disclosure may be widely applied in the field of green technology such as an electric vehicle, a battery charging station, and solar power generation and wind power generation utilizing batteries. In addition, at least some embodiments of the present disclosure may be used in an eco-friendly electric vehicle, a hybrid vehicle, and the like to prevent climate change by suppressing air pollution and greenhouse gas emissions.

According to an aspect of the present disclosure, there is provided a secondary battery including a can, an electrode assembly disposed inside the can, a rivet disposed on one surface of the can and electrically connected to a first electrode tab of the electrode assembly and a cap plate disposed on a surface opposite to the one surface, fastened to the can to close an opening of the can, and electrically connected to a second electrode tab of the electrode assembly, wherein the cap plate includes a bonding region welded to the second electrode tab, the bonding region is provided with a metal layer on an inner surface facing the second electrode tab, and the metal layer is at least partially melted by welding heat applied to the bonding region and bonded to the second electrode tab.

In some embodiments, the can may be charged with the same polarity as the second electrode tab and the cap plate.

In some embodiments, a plurality of first electrode tabs and a plurality of second electrode tabs may be provided, the plurality of first electrode tabs may provide a first bonding surface on one surface of the electrode assembly, and the plurality of second electrode tabs may provide a second bonding surface on a surface opposite to the one surface of the electrode assembly.

In some embodiments, at least a portion of the second bonding surface may be welded to the bonding region.

In some embodiments, the rivet may function as a first electrode terminal, and one surface of the can on which the rivet is disposed may be electrically insulated from the rivet such that at least a portion thereof may function as a second electrode terminal.

In some embodiments, the bonding region may have a predetermined width in a radial direction centered on a central axis of the electrode assembly.

In some embodiments, the bonding region may be disposed at a predetermined interval in a radial direction from a central axis of the electrode assembly, and may be disposed at a predetermined interval in a radial direction from an outer peripheral end of the electrode assembly toward the central axis.

In some embodiments, the bonding region may be configured to extend in a circumferential direction centered on a central axis of the electrode assembly.

In some embodiments, the bonding region may include an outer surface corresponding to the inner surface, welding heat may be applied to the outer surface by a welding device, and the metal layer may be at least partially melted according to the applied welding heat and bonded to the second electrode tab.

In some embodiments, the metal layer may include a material corresponding to the second electrode tab and may be configured on the inner surface by coating, plating, or rolling.

In some embodiments, the cap plate may include a chamber disposed adjacent to the bonding region and configured to accommodate foreign substances generated from the bonding region, and an inclined region extending obliquely downward from the bonding region toward the chamber.

In some embodiments, the inclined region may include a notch configured to rupture according to an internal pressure of the can.

In some embodiments, the inclined region may be formed to extend in a circumferential direction centered on a central axis of the electrode assembly.

In some embodiments, the inclined region may include a guide portion on an inner surface facing the inside of the can, and the guide portion may radially extend along an inclination of the inclined region.

In some embodiments, a plurality of guide portions may be provided, and the plurality of guide portions may be disposed to be spaced a predetermined interval apart in the circumferential direction.

In some embodiments, the inclined region may include a coating layer on an inner surface facing the inside of the can.

According to another aspect of the present disclosure, there is provided a method of manufacturing a secondary battery including (A) inserting an electrode assembly into a can through an opening, (B) electrically connecting a rivet disposed on one surface of the can to a first electrode tab of the electrode assembly, (C) closing the opening with a cap plate, and (D) electrically connecting a bonding region of the cap plate to a second electrode tab of the electrode assembly by welding, wherein the cap plate includes a bonding region welded to the second electrode tab, the bonding region includes a metal layer provided on an inner surface facing the second electrode tab, and operation (D) includes melting at least a portion of the metal layer by welding heat applied to the bonding region and bonding the melted portion to the second electrode tab.

In some embodiments, operation (D) may include applying welding heat to an outer surface of the bonding region by a welding device, melting at least a portion of the metal layer provided on the inner surface of the bonding region according to the applied welding heat, and bonding the melted portion to the second electrode tab.

In some embodiments, the method may further include (E) moving foreign substances generated from the bonding region along an inner surface of an inclined region and accommodating the foreign substances in a chamber disposed adjacent to the bonding region.

In some embodiments, the inclined region may include a guide portion on an inner surface facing the inside of the can, and the guide portion may radially extend along an inclination of the inclined region.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings, in which:

FIG. 1 is a schematic perspective view of a secondary battery according to one embodiment of the present disclosure;

FIG. 2 is a schematic longitudinal cross-sectional view of the secondary battery illustrated in FIG. 1;

FIG. 3 is a schematic perspective view of an electrode assembly illustrated in FIG. 2;

FIG. 4 is a schematic enlarged view of a cap plate illustrated in FIG. 2;

FIG. 5 is a schematic plan view of the cap plate illustrated in FIG. 4;

FIG. 6 is a schematic longitudinal cross-sectional view illustrating another embodiment of the cap plate illustrated in FIG. 4;

FIG. 7 is a schematic plan view of the cap plate illustrated in FIG. 6;

FIG. 8 is a first operational view illustrating a method of manufacturing the secondary battery according to one embodiment of the present disclosure; and

FIG. 9 is a second operational view illustrating the method of manufacturing the secondary battery according to one embodiment of the present disclosure.

### DETAILED DESCRIPTION OF EXEMPLARY EMBODIMENTS

Hereinafter, the present disclosure will be described in detail with reference to the accompanying drawings. However, the following description is merely exemplary and is not intended to limit the present disclosure to the specific embodiments illustrated.

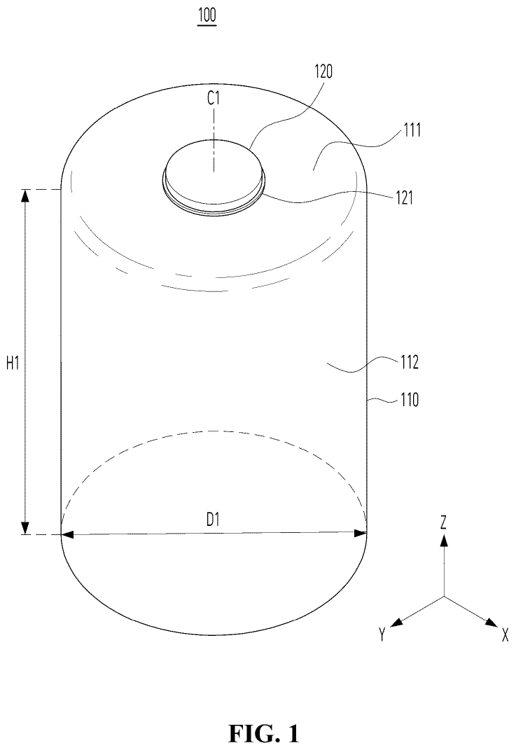

FIG. 1 is a schematic perspective view of a secondary battery according to one embodiment of the present disclosure;

For convenience of description, hereinafter, based on the coordinate axes shown in FIG. 1, an x-axis direction is referred to as a left-right direction, a y-axis direction is referred to as a front-rear direction, and a z-axis direction is referred to as an up-down direction. In addition, based on a central axis C1 illustrated in FIG. 1, a rotational direction around the central axis C1 is referred to as a circumferential direction, and the direction extending from the central axis C1 toward an outer surface of the secondary battery is referred to as a radial direction.

Referring to FIG. 1, in some embodiments, a secondary battery 100 may be formed in a cylindrical shape. The cylindrical secondary battery 100 may have a predetermined diameter D1 and height H1. For example, the secondary battery 100 may have a diameter of approximately 46 mm and a height of approximately 80 mm. In some cases, the secondary battery 100 having such a form factor may be referred to as a ‘4680 battery.’ In another example, the secondary battery 100 may have a diameter of approximately 46 mm and a height of approximately 80 mm, a diameter of approximately 46 mm and a height of approximately 95 mm, or a diameter of approximately 46 mm and a height of approximately 110 mm. In some cases, the secondary battery 100 having such a form factor may be referred to as a ‘46xx battery,’ where ‘xx’ denotes the height of the form factor. In another example, the secondary battery 100 may have a diameter of approximately 48 mm and a height of approximately 75 mm, a diameter of approximately 48 mm and a height of approximately 80 mm, or a diameter of approximately 48 mm and a height of approximately 110 mm. In some cases, the secondary battery 100 having such a form factor may be referred to as a ‘48xx battery,’ where ‘xx’ denotes the height of the form factor. However, the diameter D1 and the height H1 of the secondary battery 100 may vary as needed, and are not limited to the illustrated examples.

Meanwhile, although the cylindrical secondary battery 100 is exemplified in the present description, the form factor of the secondary battery 100 is not limited to the cylindrical shape. The secondary battery 100 according to embodiments of the present disclosure may be implemented or applied in various form factors such as a coin type, a prismatic type, or a pouch type within the scope of the technical ideas described below.

In some embodiments, the cylindrical secondary battery 100 may include a central axis C1. The central axis C1 may be formed as an imaginary axis vertically passing through the center of the secondary battery 100.

In some embodiments, the secondary battery 100 may include a can 110. The can 110 may form the exterior of the secondary battery 100 and may form an internal space for arranging an electrode assembly 130 described below. The can 110 may include an upper surface 111 and a side surface 112. The side surface 112 may be formed to extend in a circumferential direction centered on the central axis C1. In addition, a lower side of the can 110 may be open. The open lower side of the can 110 may be closed by a cap plate 150 described below.

In some embodiments, the secondary battery 100 may include a rivet 120. The rivet 120 may be disposed on the center of the upper surface 111 of the can 110. The rivet 120 may be electrically insulated from the can 110. To this end, a gasket 121 may be provided between the rivet 120 and the upper surface 111 of the can 110. The gasket 121 may be formed to electrically insulate the rivet 120 from the can 110 and mechanically seal the rivet 120 and the can 110. In some embodiments, the rivet 120 may function as an electrode terminal. For example, the rivet 120 may function as a positive electrode terminal or a negative electrode terminal. In the present description, the rivet 120 is described as a first electrode terminal. The first electrode terminal may be, for example, a positive electrode terminal.

In some embodiments, the can 110 may function as the other electrode terminal opposite to the rivet 120. For example, a partial region of the upper surface 111 of the can 110 may function as the other electrode terminal opposite to the rivet 120. In other words, a partial region of the upper surface 111 of the can 110 may function as a negative electrode terminal or a positive electrode terminal opposite to the rivet 120. In the present description, a partial region of the upper surface 111 of the can 110 is described as a second electrode terminal. The second electrode terminal may be, for example, a negative electrode terminal.

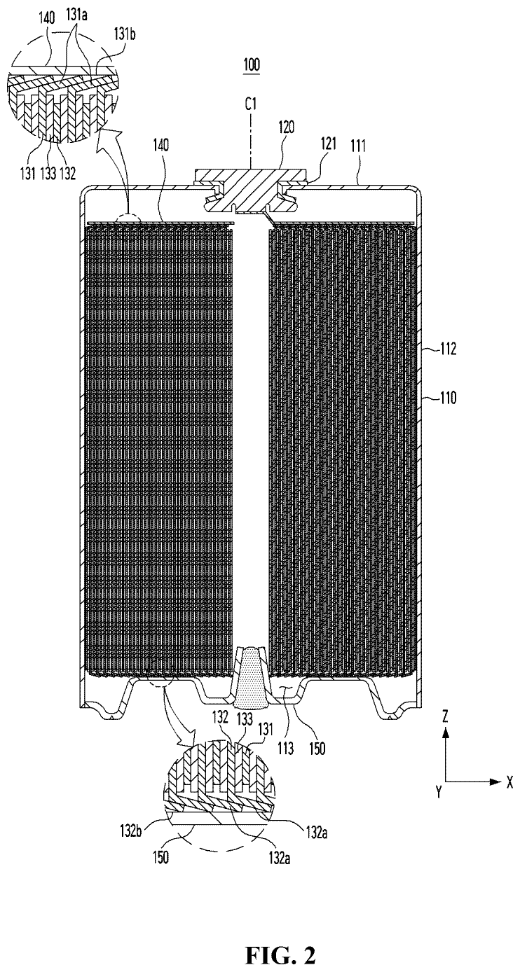

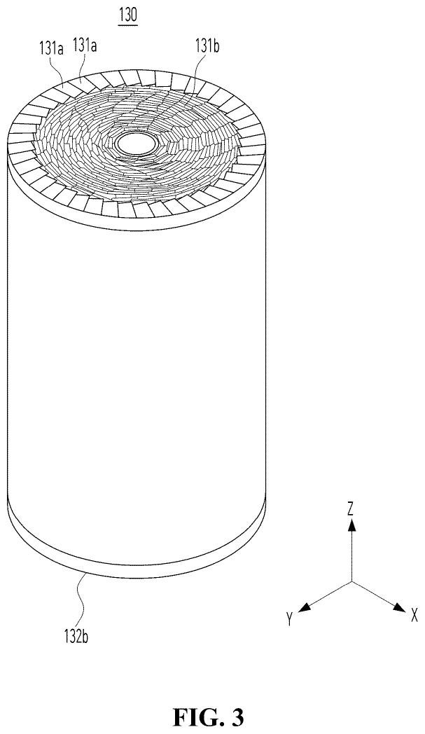

FIG. 2 is a schematic longitudinal cross-sectional view of the secondary battery illustrated in FIG. 1. FIG. 3 is a schematic perspective view of an electrode assembly illustrated in FIG. 2.

Referring to FIGS. 2 and 3, in some embodiments, the secondary battery 100 may include the electrode assembly 130. The electrode assembly 130 may be disposed inside the can 110. In some embodiments, the electrode assembly 130 may include a first electrode 131 and a second electrode 132 disposed with a separator 133 interposed therebetween. The first electrode 131 may be a positive electrode or negative electrode, and the second electrode 132 may be a negative electrode or positive electrode opposite to the first electrode 131. In the present description, the first electrode 131 is a positive electrode, and the second electrode 132 is a negative electrode.

In some embodiments, the first electrode 131 may include a positive electrode current collector and a positive electrode mixture layer disposed on at least one surface of the positive electrode current collector. For example, the positive electrode current collector may include aluminum, stainless steel, nickel, titanium, or an alloy thereof. Alternatively, the positive electrode current collector may include aluminum or stainless steel surface-treated with carbon, nickel, titanium, or silver. In some embodiments, the positive electrode mixture layer may include a positive electrode active material. The positive electrode active material may include a compound capable of reversibly intercalating and deintercalating lithium ions. For example, the positive electrode active material may include a lithium-nickel metal oxide. In some cases, the lithium-nickel metal oxide may further include at least one of cobalt, manganese, and aluminum. In some cases, the positive electrode mixture layer may further include a binder, and may optionally further include a conductive material, a thickener, and the like.

In some embodiments, the second electrode 132 may include a negative electrode current collector and a negative electrode mixture layer disposed on at least one surface of the negative electrode current collector. For example, the negative electrode current collector may include copper, stainless steel, nickel, titanium, nickel foam, copper foam, or a polymer substrate coated with a conductive metal. In some embodiments, the negative electrode mixture layer may include a negative electrode active material. The negative electrode active material may include a compound capable of reversibly intercalating and deintercalating lithium ions. For example, the negative electrode active material may include: a carbon-based material such as crystalline carbon, amorphous carbon, a carbon composite, or carbon fibers; lithium metal; a lithium alloy; a silicon-containing material; or a tin-containing material. In some cases, the negative electrode mixture layer may further include a binder, and may optionally further include a conductive material, a thickener, and the like.

The separator 133 may be disposed between the first electrode 131 and the second electrode 132. The separator 133 may limit an electrical short-circuit between the first electrode 131 and the second electrode 132 and may be configured to allow ions to flow. In some embodiments, the separator 133 may include a porous polymer film or a porous nonwoven fabric. For example, the porous polymer film may include a polyolefin-based polymer such as an ethylene polymer, a propylene polymer, an ethylene/butene copolymer, an ethylene/hexene copolymer, or an ethylene/methacrylate copolymer. In addition, the porous nonwoven fabric may include high-melting-point glass fibers or polyethylene terephthalate fibers. In some cases, the separator 133 may include a ceramic material. For example, the separator 133 may be formed by coating inorganic particles on the polymer film or dispersing the inorganic particles in the polymer film. In some cases, the separator 133 may have a single-layer or multilayer structure including the polymer film and/or the nonwoven fabric.

In some embodiments, the electrode assembly 130 may have a cylindrical roll shape in which the first electrode 131, the second electrode 132, and the separator 133 are wound around the central axis C1. In some cases, the electrode assembly 130 wound in the roll shape may be referred to as a jelly roll.

In some embodiments, the electrode assembly 130 may include a first electrode tab 131a. The first electrode tab 131a may extend from the first electrode 131. In some embodiments, the first electrode tab 131a may be provided at one end portion of the positive electrode current collector in which the positive electrode mixture layer is omitted. In the illustrated embodiment, the first electrode tab 131a is provided at an upper portion of the first electrode 131.

In some embodiments, a plurality of first electrode tabs 131a may be provided. The plurality of first electrode tabs 131a may be disposed in a winding direction of the first electrode 131. That is, the plurality of first electrode tabs 131a may be disposed in a longitudinal direction in which the first electrode 131 is wound.

In some embodiments, the plurality of first electrode tabs 131a may be bent toward the central axis C1. As illustrated in FIG. 3, the plurality of first electrode tabs 131a bent toward the central axis C1 may form a predetermined bonding surface 131b on an upper surface of the electrode assembly 130. For convenience of description, the bonding surface 131b is hereinafter referred to as the first bonding surface 131b. The first bonding surface 131b may be formed as an approximate surface formed by the plurality of first electrode tabs 131a bent toward the central axis C1.

In some embodiments, the first electrode tab 131a may be electrically connected to the rivet 120 through a current collector plate 140. The current collector plate 140 may be disposed between the first electrode tab 131a and the rivet 120. The current collector plate 140 may be welded to the first electrode tab 131a at the first bonding surface 131b to be electrically connected to the first electrode tab 131a. In addition, a central region of the current collector plate 140 may be welded to a lower end of the rivet 120 to be electrically connected to the rivet 120.

In some embodiments, the electrode assembly 130 may include a second electrode tab 132a. The second electrode tab 132a may extend from the second electrode 132. In some embodiments, the second electrode tab 132a may be provided at one end portion of the negative electrode current collector in which the negative electrode mixture layer is omitted. In the illustrated embodiment, the second electrode tab 132a is provided at a lower end portion of the second electrode 132.

Similar to the above-described first electrode tab 131a, a plurality of second electrode tabs 132a may be provided, and the plurality of second electrode tabs 132a may be disposed in a direction in which the second electrode 132 is wound. In addition, the plurality of second electrode tabs 132a may be bent toward the central axis C1. The plurality of second electrode tabs 132a bent toward the central axis C1 may form a second bonding surface 132b.

In some embodiments, the second electrode tab 132a may be electrically connected to the cap plate 150. Unlike the above-described first electrode tab 131a, the second electrode tab 132a may be directly coupled to the cap plate 150. That is, the second electrode tab 132a may be directly welded to the cap plate 150 to be electrically connected to the cap plate 150. Accordingly, the cap plate 150 and the can 110 may be electrically connected to the second electrode tab 132a and the second electrode 132.

In some embodiments, the secondary battery 100 may include the cap plate 150. The cap plate 150 may close an opening 113 of a lower side of the can 110. In some embodiments, the cap plate 150 may be welded to a lower end of the can 110 to be joined to the can 110. The inside of the can 110, with the electrode assembly 130 accommodated therein, may be properly sealed by the rivet 120 on the upper side and the cap plate 150 on the lower side.

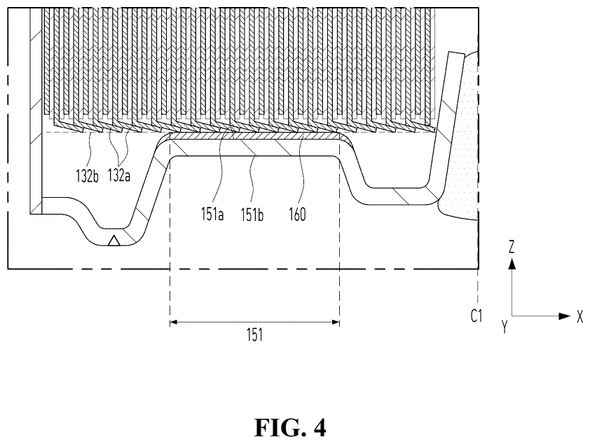

FIG. 4 is a schematic enlarged view of a cap plate illustrated in FIG. 2.

Referring to FIG. 4, in some embodiments, the secondary battery 100 may include the can 110, the electrode assembly 130 disposed inside the can 110, the rivet 120 disposed on one surface of the can 110 and electrically connected to the first electrode tab 131a of the electrode assembly 130, and the cap plate 150 disposed on a surface opposite to the one surface, fastened to the can 110 to close the opening 113 of the can 110, and electrically connected to the second electrode tab 132a of the electrode assembly 130.

Here, the cap plate 150 may include a bonding region 151 welded to the second electrode tab 132a. The bonding region 151 may include a metal layer 160 on an inner surface 151a facing the second electrode tab 132a. The metal layer 160 may be at least partially melted by the welding heat applied to the bonding region 151 and bonded to the second electrode tab 132a.

Specifically, in some embodiments, the secondary battery 100 may include the can 110. As described above, the can 110 may accommodate the electrode assembly 130 therein.

In some embodiments, the can 110 may be charged with the same polarity as the second electrode tab 132a and the cap plate 150. Specifically, the second electrode tab 132a may be electrically connected to the cap plate 150 through the bonding region 151, and the cap plate 150 may in turn be electrically connected to the can 110. Accordingly, the second electrode tab 132a, the cap plate 150, and the can 110 may be charged with the same polarity. For example, the second electrode tab 132a, the cap plate 150, and the can 110 may be charged as a negative electrode.

Meanwhile, in some embodiments, the secondary battery 100 may include the electrode assembly 130. As described above, the electrode assembly 130 may be accommodated inside the can 110. The electrode assembly 130 may also include the first electrode tab 131a on one surface (top surface) thereof, and the second electrode tab 132a on the opposite surface (bottom surface) thereof.

In some embodiments, there may be a plurality of first electrode tabs 131a and second electrode tabs 132a. The plurality of first electrode tabs 131a may also form the first bonding surface 131b on one surface (top surface) of the electrode assembly 130, and the plurality of second electrode tabs 132a may form the second bonding surface 132b on the surface (bottom surface) opposite to the one surface.

In some embodiments, the first bonding surface 131b may be electrically connected to the rivet 120 through the current collector plate 140 as described above. The second bonding surface 132b may be at least partially welded to the bonding region 151. The second bonding surface 132b may be directly electrically connected to the bonding region 151 without a connecting component such as the current collector plate.

Meanwhile, in some embodiments, the secondary battery 100 may include the rivet 120. In some embodiments, the rivet 120 may function as a first electrode terminal. For example, the rivet 120 may function as a positive electrode terminal. In addition, the one surface (top surface) of the can 110 on which the rivet 120 is disposed may be electrically insulated from the rivet 120, and at least a portion thereof may function as a second electrode terminal. For example, a region of the upper surface 111 of the can 110 on which the rivet 120 is disposed may function as a negative electrode terminal. The rivet 120 that functions as a first electrode terminal and the region of the upper surface 111 of the can 110 that functions as a second electrode terminal may be electrically insulated by the gasket 121.

Meanwhile, in some embodiments, the secondary battery 100 may include the cap plate 150. The cap plate 150 may be fastened to a lower end of the can 110 to close the opening 113. The cap plate 150 may also be electrically connected to the second electrode tab 132a.

In some embodiments, the cap plate 150 may include the bonding region 151. The bonding region 151 may refer to a partial region of the cap plate 150 that is bonded to the second electrode tab 132a. In the illustrated embodiment, the bonding region 151 is exemplified as a region spaced a predetermined interval apart from the central axis C1 and having a predetermined width in a radial direction. The bonding region 151 may include the inner surface 151a and an outer surface 151b. The inner surface 151a may refer to one surface of the bonding region 151 disposed to face the inside of the can 110, and the outer surface 151b may refer to the other surface of the bonding region 151 disposed to face the outside of the can 110. The inner surface 151a of the bonding region 151 may be disposed to face the second electrode tab 132a.

In some embodiments, the inner surface 151a of the bonding region 151 may be provided with the metal layer 160. The metal layer 160 may be formed of a material different from the bonding region 151 and the cap plate 150. For example, the metal layer 160 may be formed of a material corresponding to the second electrode tab 132a. The metal layer 160 may be at least partially melted by the welding heat applied to the bonding region 151. Accordingly, the metal layer 160 may be bonded to the second electrode tab 132a. That is, the bonding region 151 may be bonded to the second electrode tab 132a through the metal layer 160. Accordingly, the bonding region 151 may be directly electrically connected to the second electrode tab 132a without a connecting component such as the current collector plate.

In some embodiments, welding heat may be applied to the outer surface 151b of the bonding region 151 by a welding device. For example, a laser beam for applying welding heat may be irradiated onto the outer surface 151b of the bonding region 151. The welding heat irradiated onto the outer surface 151b of the bonding region 151 may be transferred to the inner surface 151a of the bonding region 151 along a thickness direction of the bonding region 151. The metal layer 160 provided on the inner surface 151a of the bonding region 151 may be melted by the welding heat thus transferred and fused to the second electrode tab 132a.

In some embodiments, the metal layer 160 may be formed of a material corresponding to the second electrode tab 132a. For example, the second electrode tab 132a may include copper or a copper alloy as the material, and the metal layer 160 may be formed of copper or a copper alloy corresponding thereto. The metal layer 160 may be provided on the inner surface 151a of the bonding region 151 by coating, plating, or rolling. In some cases, the bonding region 151 and the metal layer 160 may be provided in the form of a clad metal.

In some embodiments, the metal layer 160 may function to reduce damage to the second electrode tab 132a due to welding heat. That is, melting of the metal layer 160 may function to replace or reduce the melting of the second electrode tab 132a in the bonding of the bonding region 151 and the second electrode tab 132a. In addition, the metal layer 160 may contribute to implementing the bonding of the bonding region 151 and the second electrode tab 132a with a relatively small heat input. Accordingly, the metal layer 160 may induce more complete bonding between the inner surface 151a of the bonding region 151 and the second electrode tab 132a. In addition, the integrity of the electrical connection between the bonding region 151 and the second electrode tab 132a may be ensured.

However, in the embodiments of the present disclosure, the melting of the metal layer 160 does not necessarily completely replace the melting of the second electrode tab 132a. That is, in the embodiments of the present disclosure, the melting of the second electrode tab 132a is not completely excluded. In some embodiments, the second electrode tab 132a may be at least partially melted by the welding heat directly or indirectly transferred through the bonding region 151. In addition, the melted second electrode tab 132a may form a weld bead together with the metal layer 160. In this case, the metal layer 160 may function to induce good fusion between the bonding region 151 and the second electrode tab 132a while reducing damage to the second electrode tab 132a.

Meanwhile, in the present description, the term “welding” may encompass various bonding methods in which a predetermined amount of heat is applied and a base material and/or a filler metal is melted to bond. For example, in the present description, welding may be used to include brazing, soldering, and the like.

Although not illustrated, in some embodiments, the metal layer 160 may be provided on the entire inner surface of the cap plate 150 including the bonding region 151. In this case, the cap plate 150 may be manufactured by processing a plate-shaped member having the metal layer 160 provided on one surface (the inner surface) into a predetermined shape. In addition, an additional process for forming the metal layer 160 may be appropriately omitted.

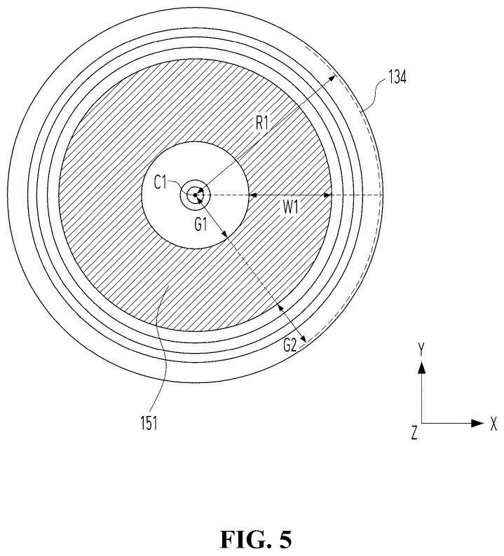

FIG. 5 is a schematic plan view of the cap plate illustrated in FIG. 4.

Referring to FIG. 5, in some embodiments, the bonding region 151 may be formed to extend in a circumferential direction centered on the central axis C1 of the electrode assembly 130. The bonding region 151 extending in the circumferential direction may have a complete circular shape, a partial circular shape, or a discontinuous circular shape. In the illustrated embodiment, the bonding region 151 is illustrated as having a completely circular ring shape.

However, the shape of the bonding region 151 is not necessarily limited to the illustrated circle. The bonding region 151 may have various shapes other than the exemplified shape as long as it is in a shape capable of appropriately electrically connecting to the second electrode tab 132a. For example, the bonding region 151 may have a polygonal shape or an irregular shape that is not specifically defined.

In some embodiments, the bonding region 151 may have a predetermined width W1 in a radial direction centered on the central axis C1 of the electrode assembly 130. That is, the bonding region 151 may have a predetermined width W1 in a radial direction in a plan view. The bonding region 151 may have a predetermined width W1 in the radial direction and extend in the circumferential direction to form a circular ring shape. For example, the bonding region 151 may have a width W1 of 20 to 80% of the entire radius R1 of the electrode assembly 130. In some embodiments, when the width W1 of the bonding region 151 is too small, it may be difficult to secure an appropriate electrical connection path between the second bonding surface 132b and the bonding region 151.

In some embodiments, the bonding region 151 may be disposed spaced a predetermined interval G1 apart from the central axis C1 of the electrode assembly 130 in the radial direction. For example, the bonding region 151 may be disposed at a distance G1 of 10 to 40% of the radius R1 of the electrode assembly 130 from the central axis C1. In some embodiments, when the bonding region 151 is disposed too close to the central axis C1, welding defects or electrode damage may occur due to a non-uniform distribution of the second electrode tabs 132a.

In some embodiments, the bonding region 151 may be disposed to be spaced a predetermined interval G2 apart from an outer peripheral end 134 of the electrode assembly 130 toward the central axis C1 in the radial direction. For example, the bonding region 151 may be disposed at an interval G2 of 10 to 40% of the radius R1 of the electrode assembly 130 from the outer peripheral end 134. This is intended, similarly to the above, to prevent welding defects or electrode damage.

The bonding region 151 as described above may be bonded to the second bonding surface 132b in an intermediate region in the radial direction of the second bonding surface 132b. Accordingly, more robust bonding with the second bonding surface 132b and the second electrode tab 132a may be achieved. In addition, within the second bonding surface 132b, a region adjacent to the central axis C1 and/or a region adjacent to the outer peripheral end 134 may have a relatively non-uniform arrangement of the second electrode tabs 132a. Accordingly, by allowing the bonding region 151 to be bonded to the second electrode tab 132a in a region spaced a predetermined interval from the central axis C1 and the outer peripheral end 134, the bonding integrity between the bonding region 151 and the second electrode tab 132a may be appropriately ensured. In addition, by performing the welding in a region in which the second electrode tabs 132a relatively uniformly cover the second bonding surface 132b, the occurrence of welding by-products and damage to the electrode caused by the welding heat may be prevented.

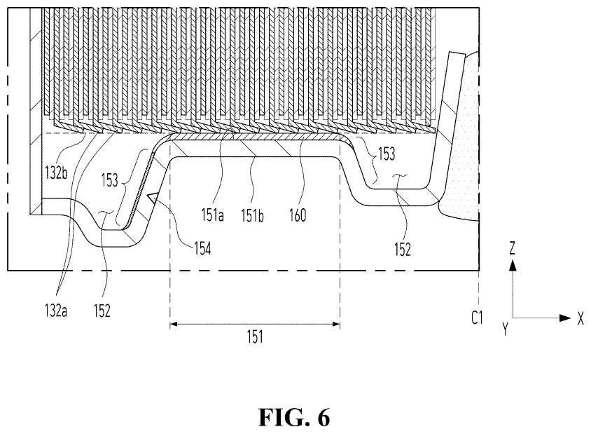

FIG. 6 is a schematic longitudinal cross-sectional view illustrating another embodiment of the cap plate illustrated in FIG. 4.

Referring to FIG. 6, in some embodiments, the cap plate 150 may include a chamber 152 and an inclined region 153. The chamber 152 may be disposed adjacent to the bonding region 151 and formed to accommodate foreign substances generated from the bonding region 151. In addition, the inclined region 153 may extend obliquely downward from the bonding region 151 toward the chamber 152.

Specifically, in some embodiments, the cap plate 150 may have the chamber 152 formed therein. The chamber 152 may be formed by recessing a portion of the cap plate 150. An upper side of the chamber 152 may be formed to be open. The chamber 152 may be disposed adjacent to the bonding region 151. In the illustrated embodiment, the chamber 152 is disposed adjacent to the bonding region 151 with the inclined region 153 interposed therebetween. The chamber 152 may function to accommodate foreign substances generated from the bonding region 151. For example, the chamber 152 may function to accommodate foreign substances such as welding spatter generated during the welding of the bonding region 151.

The inclined region 153 may be disposed between the bonding region 151 and the chamber 152. The inclined region 153 may extend obliquely downward from the bonding region 151 toward the chamber 152. That is, the inclined region 153 may be formed as a type of inclined surface. The inclined region 153 may function to guide foreign substances to the chamber 152. For example, foreign substances such as welding spatter generated during the welding of the bonding region 151 may be moved along the inclination of the inclined region 153 and guided into the chamber 152.

In some embodiments, a plurality of sets of the chamber 152 and the inclined region 153 may be provided. For example, in the illustrated embodiment, one set of the chamber 152 and the inclined region 153 is provided on each of the inner and outer sides in the radial direction with the bonding region 151 interposed therebetween.

In some embodiments, the inclined region 153 may be provided with a notch 154. The notch 154 may be formed to rupture according to an internal pressure of the can 110. That is, the notch 154 may function as a vent for coping with excessive internal pressure increases or swelling of the can 110. In the illustrated embodiment, the notch 154 is exemplified as being provided in the inclined region 153 disposed radially outward.

In some embodiments, the notch 154 may maintain proper functions by being disposed in the inclined region 153. In detail, in some embodiments, the bonding of the bonding region 151 may be performed by applying welding heat to the outer surface 151b of the bonding region 151 while the cap plate 150 is previously disposed on the can 110. In addition, in the bonding region 151, foreign substances such as welding spatter may be generated during welding. Here, the foreign substances may be guided along the inclination of the inclined region 153 and collected in the chamber 152. In addition, accumulation or adhesion of foreign substances may be restricted due to the inclination of the inclined region 153. The notch 154 may be disposed in the inclined region 153, thereby preventing malfunction caused by foreign substances.

In some embodiments, the inclined region 153 may include a coating layer 153a on an inner surface facing the inside of the can 110. The coating layer 153a may facilitate smoother movement of foreign substances through the inclined region 153. In addition, the coating layer 153a may more effectively restrict the accumulation or adhesion of foreign substances at a position in which the notch 154 is disposed. For example, the coating layer 153a may include a ceramic coating, a fluororesin coating, or the like.

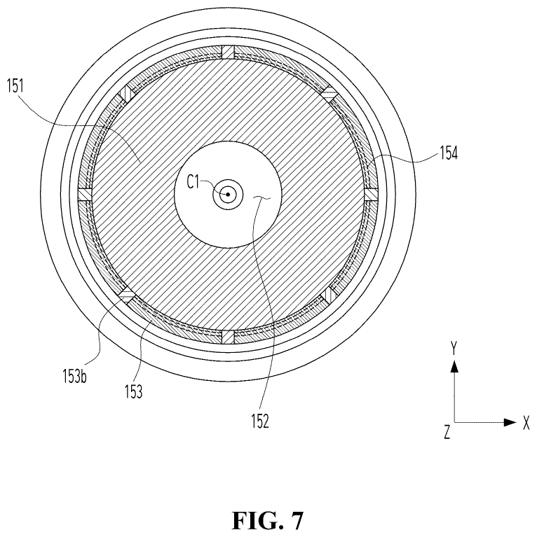

FIG. 7 is a schematic plan view of the cap plate illustrated in FIG. 6.

Referring to FIG. 7, in some embodiments, the bonding region 151 may be formed to extend in a circumferential direction centered on the central axis C1 of the electrode assembly 130. In addition, the inclined region 153 may be formed to extend in the circumferential direction to correspond to the bonding region 151. In the illustrated embodiment, the bonding region 151 is illustrated as having a completely circular ring shape, and the inclined region 153 has a circular ring shape corresponding thereto.

In some embodiments, the inclined region 153 may include a guide portion 153b on an inner surface facing the inside of the can 110. In addition, the guide portion 153b may radially extend along the inclination of the inclined region 153. Specifically, the guide portion 153b may be formed on the inner surface of the inclined region 153. For example, the guide portion 153b may be implemented as a protrusion, a groove, or other similar mechanical shapes. The guide portion 153b may extend along the inclination of the inclined region 153 to assist the movement of foreign substances.

In some embodiments, the notch 154 may be formed to extend along the circumferential direction to correspond to the inclined region 153. In the illustrated embodiment, the notch 154 is exemplified as having a circular ring shape corresponding to the inclined region 153. In some embodiments, there may be a plurality of guide portions 153b, and the plurality of guide portions 153b may be disposed at predetermined intervals along the circumferential direction. In the illustrated embodiment, the number of guide portions 153b is exemplified as being eight. The plurality of guide portions 153b may assist the movement of foreign substances at respective positions thereof.

In some embodiments, the plurality of guide portions 153b may function to adjust the rupture strength of the notch 154. That is, the plurality of guide portions 153b may have both a function of assisting the movement of foreign substances and a function of adjusting the rupture strength of the notch 154. For example, the guide portion 153b having a protrusion shape may increase the structural strength of the inclined region 153, and accordingly, the rupture strength of the notch 154 may vary depending on the shape, number, and position of the guide portion 153b.

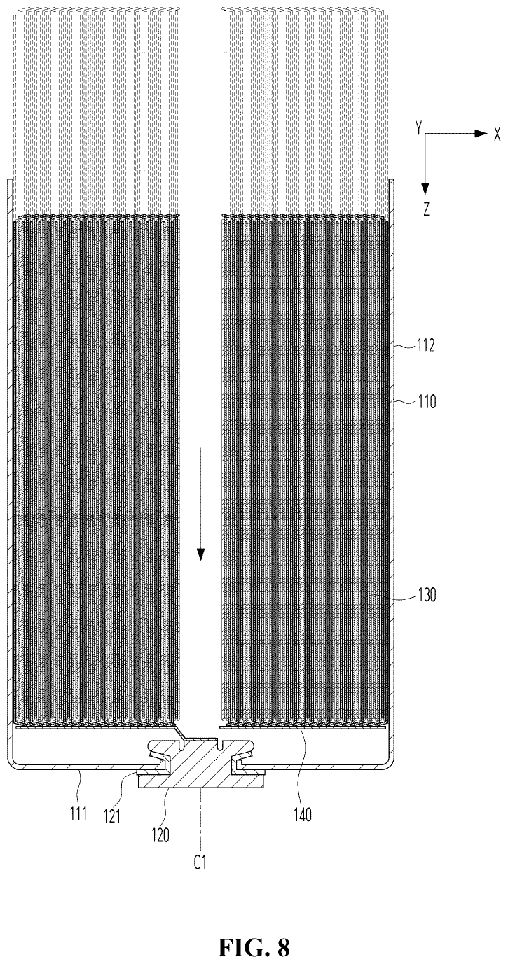

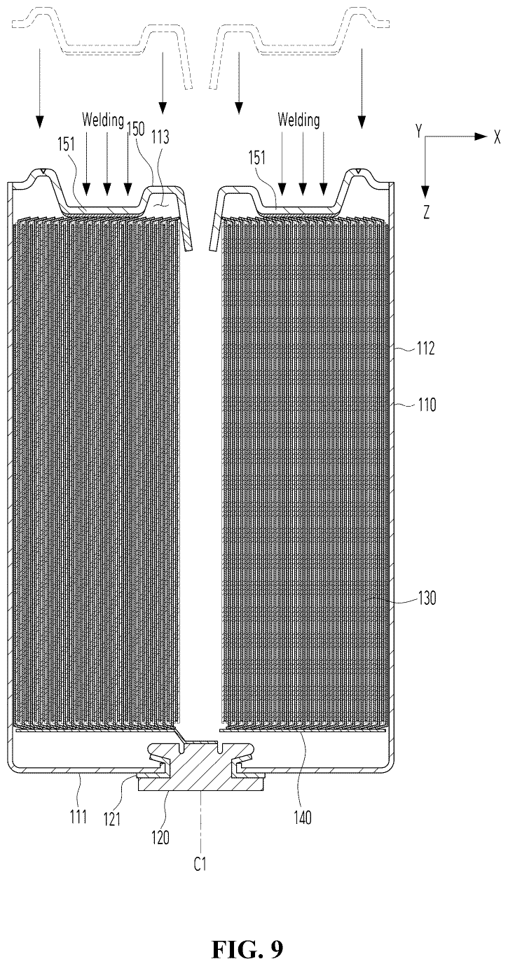

FIG. 8 is a first operational view illustrating a method of manufacturing the secondary battery according to one embodiment of the present disclosure. FIG. 9 is a second operational view illustrating the method of manufacturing the secondary battery according to one embodiment of the present disclosure.

According to another aspect of the present disclosure, a method of manufacturing the secondary battery may be provided. FIGS. 8 and 9 illustrate and summarize main operational states in the method of manufacturing the secondary battery according to one embodiment of the present disclosure. For convenience of description, it is noted that FIGS. 8 and 9 illustrate the secondary battery shown in FIG. 1 and the like upside down.

In some embodiments, the method of manufacturing the secondary battery may include (A) inserting an electrode assembly 130 into a can 110 through an opening 113, (B) electrically connecting a rivet 120 disposed on one surface of the can 110 to a first electrode tab 131a of the electrode assembly 130, (C) closing the opening 113 by a cap plate 150, and (D) electrically connecting a bonding region 151 of the cap plate 150 to a second electrode tab 132a of the electrode assembly 130 by welding.

Here, the cap plate 150 may include the bonding region 151 welded to the second electrode tab 132a, and the bonding region 151 may be provided with a metal layer 160 on an inner surface facing the second electrode tab 132a. In addition, operation (D) may include melting at least a portion of the metal layer 160 by the welding heat applied to the bonding region 151 and bonding the melted portion to the second electrode tab 132a.

Specifically, referring to FIG. 8, the rivet 120 is fastened to one side of the can 110 (a lower side in the diagram), and the electrode assembly 130 may be inserted into the can 110 (operation (A)). The electrode assembly 130 may be inserted into the can 110 through the opening 113 on the side opposite to the rivet 120. In some cases, after the rivet 120 is fastened, the can 110 may be disposed upside down, and the electrode assembly 130 may be inserted. For reference, FIG. 8 illustrates this upside-down arrangement.

In some embodiments, a current collector plate 140 may be pre-fastened to one side of the electrode assembly 130 (a lower side in the diagram). That is, the electrode assembly 130 may be inserted into the can 110 in a state in which the current collector plate 140 is fastened. Subsequently, the rivet 120 may be electrically connected to the electrode assembly 130. That is, the rivet 120 may be welded to the current collector plate 140 and thus electrically connected to the first electrode tab 131a of the electrode assembly 130.

Subsequently, the cap plate 150 may be fastened to the opening 113 (operation (C)). The opening 113 may be closed by the cap plate 150. In some cases, the cap plate 150 may close the opening 113 in a temporarily assembled state on the can 110, or may close the opening 113 in a completely assembled state on the can 110 through welding or the like.

Referring to FIG. 9, subsequently, the bonding region 151 of the cap plate 150 may be electrically connected to the second electrode tab 132a (operation (D)). In some embodiments, the bonding region 151 may be directly bonded to the second electrode tab 132a through welding. Specifically, operation (D) may be performed by applying welding heat to an outer surface 151b of the bonding region 151 by a welding device. According to the applied welding heat, at least a portion of the metal layer 160 provided on an inner surface 151a of the bonding region 151 may be melted and bonded to the second electrode tab 132a. As described above, the metal layer 160 induces proper fusion between the bonding region 151 and the second electrode tab 132a and ensures the integrity of the electrical connection.

In some embodiments, the method of manufacturing the secondary battery may further include (E) accommodating foreign substances generated during the bonding of the bonding region 151 in a chamber 152. Specifically, after operation (D), the secondary battery may be disposed upside down again. That is, the secondary battery may be disposed so that the rivet 120 faces upward. In addition, an electrolyte may be injected into the can 110. Here, the foreign substances generated during the bonding of the bonding region 151 may be guided along the inner surface of the inclined region 153 and accommodated in the chamber 152 disposed adjacent to the bonding region 151.

In some embodiments, the inclined region 153 may include a guide portion 153b on an inner surface facing the inside of the can 110, and the guide portion 153b may be formed to radially extend along the inclination of the inclined region 153. As described above, the guide portion 153b may assist the movement of the foreign substances along the inner surface of the inclined region 153 so that the foreign substances may be properly accommodated in the chamber 152.

As described above, the embodiments of the present disclosure may provide a secondary battery and a method of manufacturing the secondary battery.

In addition, at least some embodiments of the present disclosure may contribute to reducing manufacturing costs by simplifying components for manufacturing the secondary battery.

Further, at least some embodiments of the present disclosure may contribute to reducing assembly defects by inducing reliable bonding between the electrode tab and the bonding region.

Some embodiments of the present disclosure can provide a secondary battery and a method of manufacturing the secondary battery.

In addition, some embodiments of the present disclosure can provide a secondary battery and a method of manufacturing the secondary battery that can reduce manufacturing costs.

In addition, some embodiments of the present disclosure can provide a secondary battery and a method of manufacturing the secondary battery that can reduce assembly defects.

The above description is merely an example of applying the principles of the present disclosure, and other configurations may be further included without departing from the scope of the present disclosure.

What is claimed is:

1. A secondary battery comprising:
a can;
an electrode assembly disposed inside the can;
a rivet disposed on one surface of the can and electrically connected to a first electrode tab of the electrode assembly; and
a cap plate disposed on a surface opposite to the one surface, fastened to the can to close an opening of the can, and electrically connected to a second electrode tab of the electrode assembly,
wherein the cap plate includes a bonding region welded to the second electrode tab,
the bonding region is provided with a metal layer on an inner surface facing the second electrode tab, and
the metal layer is at least partially melted by welding heat applied to the bonding region and bonded to the second electrode tab.

2. The secondary battery of claim 1, wherein the can is charged with the same polarity as the second electrode tab and the cap plate.

3. The secondary battery of claim 1, wherein a plurality of first electrode tabs and a plurality of second electrode tabs are provided,
the plurality of first electrode tabs provide a first bonding surface on one surface of the electrode assembly, and
the plurality of second electrode tabs provide a second bonding surface on a surface opposite to the one surface of the electrode assembly.

4. The secondary battery of claim 3, wherein at least a portion of the second bonding surface is welded to the bonding region.

5. The secondary battery of claim 1, wherein the rivet functions as a first electrode terminal, and
one surface of the can on which the rivet is disposed is electrically insulated from the rivet such that at least a portion thereof functions as a second electrode terminal.

6. The secondary battery of claim 1, wherein the bonding region has a predetermined width in a radial direction centered on a central axis of the electrode assembly.

7. The secondary battery of claim 1, wherein the bonding region is disposed at a predetermined interval in a radial direction from a central axis of the electrode assembly, and is disposed at a predetermined interval in a radial direction from an outer peripheral end of the electrode assembly toward the central axis.

8. The secondary battery of claim 1, wherein the bonding region is configured to extend in a circumferential direction centered on a central axis of the electrode assembly.

9. The secondary battery of claim 1, wherein the bonding region includes an outer surface corresponding to the inner surface,
welding heat is applied to the outer surface by a welding device, and
the metal layer is at least partially melted according to the applied welding heat and bonded to the second electrode tab.

10. The secondary battery of claim 1, wherein the metal layer includes a material corresponding to the second electrode tab and is configured on the inner surface by coating, plating, or rolling.

11. The secondary battery of claim 1, wherein the cap plate includes:
a chamber disposed adjacent to the bonding region and configured to accommodate foreign substances generated from the bonding region; and
an inclined region extending obliquely downward from the bonding region toward the chamber.

12. The secondary battery of claim 11, wherein the inclined region includes a notch formed to rupture according to an internal pressure of the can.

13. The secondary battery of claim 11, wherein the inclined region is configured to extend in a circumferential direction centered on a central axis of the electrode assembly.

14. The secondary battery of claim 13, wherein the inclined region includes a guide portion on an inner surface facing the inside of the can, and
the guide portion radially extends along an inclination of the inclined region.

15. The secondary battery of claim 14, wherein a plurality of guide portions are provided, and
the plurality of guide portions are disposed to be spaced a predetermined interval apart in the circumferential direction.

16. The secondary battery of claim 11, wherein the inclined region includes a coating layer on an inner surface facing the inside of the can.

17. A method of manufacturing a secondary battery, comprising:
(A) inserting an electrode assembly into a can through an opening;
(B) electrically connecting a rivet disposed on one surface of the can to a first electrode tab of the electrode assembly;
(C) closing the opening with a cap plate; and
(D) electrically connecting a bonding region of the cap plate to a second electrode tab of the electrode assembly by welding,
wherein the cap plate includes a bonding region welded to the second electrode tab,
the bonding region is provided with a metal layer on an inner surface facing the second electrode tab, and
operation (D) includes melting at least a portion of the metal layer by welding heat applied to the bonding region and bonding the melted portion to the second electrode tab.

18. The method of claim 17, wherein operation (D) includes applying welding heat to an outer surface of the bonding region by a welding device, melting at least a portion of the metal layer provided on the inner surface of the bonding region according to the applied welding heat, and bonding the melted portion to the second electrode tab.

19. The method of claim 17, further comprising (E) moving foreign substances generated from the bonding region along an inner surface of an inclined region and accommodating the foreign substances in a chamber disposed adjacent to the bonding region.

20. The method of claim 19, wherein the inclined region includes a guide portion on an inner surface facing the inside of the can, and
the guide portion radially extends along an inclination of the inclined region.
